(19) United States
(12) Patent Application Publication
(10) Pub. No.: US 2006/0184960 A1
(43) Pub. Date: Aug. 17, 2006

(54) Method and system for enabling commerce from broadcast content

(75) Inventors: Chris Horton, Santa Monica, CA (US); Dmitry Radbel, Pacific Palasades, CA (US); Howard Soroka, Santa Monica, CA (US); Jeffrey Bronikowski, New York, NY (US)

Correspondence Address: DARBY & DARBY P.C., P. O. BOX 5257, NEW YORK, NY, 10150-5257, US

(73) Assignee: Universal Music Group, Inc., Santa Monica, CA (US)

(21) Appl. No.: 11/354,351

(22) Filed: Feb. 14, 2006

Related U.S. Application Data
(60) Provisional application No. 60/653,219, filed on Feb. 14, 2005.

(51) Int. Cl. H04N 7/025; H04N 7/173; H04N 7/10; H04N 7/16

(52) U.S. Cl. 725/25; 725/32; 725/109; 725/110

(57) ABSTRACT

The present invention is a method and system of allowing a user to receive additional information regarding broadcast content. A user's playback device is provided with an “Info Button” that can be clicked by the user to tag the content or sub-content while experiencing the content or sub-content. The user can be provided with information and/or commerce opportunities relating to the tagged content. Identifiers, markers and fingerprints that can identify the individual content and sub-content can be captured by the playback device when the Info Button is clicked. A Content ID can be transmitted or played back with the content and can be a unique identifier to the content. Further, a Broadcast ID, a FSA ID and a Device Manufacturer ID can also be transmitted or associated with the content.

### RELATED APPLICATIONS

This application claims priority pursuant to 35 U.S.C. §119 from Provisional Patent Application Ser. No. 60/653,219 filed Feb. 14, 2005. The entire disclosure of the provisional application is hereby incorporated by reference.

### FIELD OF THE INVENTION

The present invention enables commerce from both audio and video broadcast content such as AM/FM radio, digital radio, satellite radio, internet radio, analogue TV or digital TV broadcasts using content, value-chain participant identifiers and identifier resolution services. Individual pieces of content are associated with identifiers which can be used by competing identifier resolution services to present users with purchase opportunities or information for the content that interests them.

### BACKGROUND OF THE INVENTION

Currently, listening and/or viewing broadcast content such as AM/FM Radio, satellite radio, digital radio systems, and video broadcasts is a passive experience. If a user is playing content, for example hearing a song or seeing a commercial that the user likes, there is no easy way for the user to find more information about the content. Typically the user can receive, for example, the artist's name, track name, or information played with the commercial. Further, typically there is no mechanism for a user to purchase the content in some form (e.g. a CD or digital download) or receive more information related to the commercial (e.g. directions to the retail location). Typically a user is forced to try and remember the few details given or attempt to write down the information before the content ends. Additionally, sub-content can be “buried” in a primary broadcast and a user has no way of determining any information regarding the sub-content. For example, songs can be played in the background of most television programs and a user is unable to determine the title and artist of the clip. Additionally, products can be used in television shows and the user does not have a way to determine the brand name of the product.

Thus, there is a need in the art for a system and method that allows a user to express interest in specific pieces of broadcast content (e.g. a song, ad, or sub-content) and then obtain information or commerce opportunities related to that piece of content.

### SUMMARY OF THE INVENTION

The present invention is a method and system of allowing a user to receive additional information regarding broadcast content. A user's playback device is provided with an “Info Button” that can be clicked by the user to tag the content or sub-content while experiencing the content or sub-content. The user can be provided with information and/or commerce opportunities relating to the tagged content.

Identifiers, markers and fingerprints that can identify the individual content and sub-content can be captured by the playback device when the Info Button is clicked. A Content ID can be transmitted or played back with the content and can be a unique identifier to the content. Further, a Broadcast ID, a FSA ID and a Device Manufacturer ID can also be transmitted or associated with the content and are described further below.

In an embodiment, content fingerprints and other content markers are used to identify the content or sub-content. Content fingerprints can be a number computed from the content. Further, content markers can be a sample of the content, a time and date stamp, a length of the broadcast of the content or any other identifier of the content. The content fingerprint or content marker is then analyzed to determine the Content ID or used as the Content ID itself. The fingerprint analysis can look at the beats per minute, high and low frequency sounds and instruments to determine the unique fingerprint. For content markers, an example is a 5 or 10 second sample of the content can be taken and analyzed to determine the content. Another example, a time and date identifier can be compared to a play list to determine the content played at the particular time. Further, radio transmits signals that can be converted to text identifiers by the playback device. The text is typically the name of the broadcaster, content and content artist. The signal and/or text can be analyzed to determine a Content ID and a Broadcaster ID. Similar signals are transmitted for television broadcasts as well. Examples of identifiers and/or markers present in the broadcast stream are Radio Data Systems (RDS) in the case of FM radio, embedded metadata in the case of digital radio or satellite radio, and embedded identifiers in audio watermarks.

A Broadcast ID identifies the broadcaster of the content. The Broadcast ID can be captured from interrogating the playback device. Alternately, all broadcasters licensed under the FCC (Federal Communication Commission) are required to play a broadcaster identification at specific time intervals. The Broadcast ID can be determined from the broadcaster identification and further, the broadcast station can be monitored for a specific amount of time, regardless if the user changes the broadcast station, to wait to retrieve the broadcaster information. As above, the Broadcast ID can be determined directly or indirectly through the analysis of other data. In an embodiment, a central body can provide unique Broadcast IDs for each broadcaster and/or unique Device Manufacturer ID for each device manufacture.

A Device Manufacturer ID identifies the playback device utilized by the user when the Info Button was pressed. The Device Manufacturer ID can take the form of a unique serial number of the playback device, a manufacturer identifier, or generic model number. The Device Manufacturer ID can be used for multiple functions. The Device Manufacturer ID can identify the manufacture for compensation in the value chain. In an alternate embodiment, the use of the serial number can allow the device to be linked to a specific user and user accounts.

Another embodiment can incorporate a User ID to determine the user requesting the additional information. The User ID can be stored in the playback device on a removable storage device, or on a connected device such as a computer, laptop, PDA, MP3 player and cell phone. The User ID can identify a user and allow a user account and preference information to be accessed remotely or the User ID can contain or be used to reference detailed information regarding the user. In an embodiment, information contained in or referenced by the User ID are financial information (e.g., credit card number or paypal account) to complete a commercial transaction for the content. The User ID can also indicate preferences as to the preferred formats for the content, receiving devices used to receive the information regarding the content and vendor/retailer preferences.

Further identifiers can include a Position ID, transmitted from a GPS signal, to allow the FSA to determine the location of the user. Alternatively, the Position ID may be the users address, phone number, zip code, country, or similar information that can be used to determine the user's physical location. This allows the FSA to determine the best delivery location or value-chain provider to use. For example, if a user requests information relating to a played advertising for a commercial location, the information returned can be directions to the closest commercial location (e.g. clicking the Info Button during a fast food restaurant commercial can return directions to the nearest fast food restaurant to the present location of the user).

The content, broadcast, device, user and other identifiers can be transmitted directly from the receiving device to the FSA for resolution. Alternately, the identifiers can be captured on portable media, for example flash media or written to a re-writable CD/DVD which can be part of the playback device. The portable media can be inserted into a computer to upload the identifiers. Alternatively the receiving device and computer may communicate wirelessly. Software can be used to read the identifiers and forward them to the FSA.

The FSA resolves the identifiers into specific commerce opportunities. Resolution services map the identifiers to specific product offerings such as the opportunity to buy tagged content on a CD or as a digital download, and return (for example) web links to those commerce opportunities. Other commerce opportunities include using the Broadcast ID and/or Device Manufacturer ID to determine special commerce opportunities only available to users who requested the information while playing the content from a specific provider/broadcaster or using a specific device.

The FSA is usually invisible to the user. The FSA, in one embodiment, processes the identifiers and redirects users to existing retailers. When a sale is completed, the facilitating FSA may be paid an affiliate fee which it can share with the other value-chain participants such as the broadcaster and hardware manufacturer, if their identifiers were included in the communication from the user to the FSA that resulted in the sale.

A primary different between the present invention and old ideas about how to monetize broadcast content is the use of FSAs. Typically, every broadcaster cannot deal with multiple retailers so a middleman is needed. The present invention can incorporate a single FSA handling all of the transactions for multiple broadcasters and retailers. Alternately, a single middleman for all broadcasters may not be possible, so the system supports competing FSAs. In one embodiment, different broadcasters can use different FSAs. Alternately, a single broadcaster can use multiple FSAs. Individual FSAs can also have arrangements with multiple retailers, and the FSA's business deals with broadcasters, device manufacturers and the retailers will determine what options are presented to users. Optionally, user context information such as format or quality preferences, territory, preferred retailers/vendors and computer platform can assist in narrowing a user's options.

Another embodiment supports value chain identifiers, where a user's click of the Info Button results in a sale or ad click. Then, both the broadcaster and hardware manufacturer of the device on which the broadcast was received can benefit because the FSA tracks all participants in the value chain. Particularly, the relationships between all value-chain participants (FSA, broadcaster, retailer, device manufacturer) can all be reduced to electronic contracts and can be resolved using systems and methods described in pending application Ser. Nos. 09/471,971 and 09/614,106 owned by the same assignee and incorporated herein by reference.

### BRIEF DESCRIPTION OF THE DRAWING FIGURES

The above and still further objects, features and advantages of the present invention will become apparent upon consideration of the following detailed description of a specific embodiment thereof, especially when taken in conjunction with the accompanying drawings wherein like reference numerals in the various figures are utilized to designate like components, and wherein:

FIG. 1 is a system diagram of the present invention;

FIG. 2 is a system diagram of an embodiment of the present invention;

FIGS. 3a and 3b are illustrations of user displays of the present invention;

FIG. 4 is a system diagram of rectifying the FSA ID of the present invention;

FIG. 5 is a diagram of identifiers in video content and

FIG. 6 is a flow chart illustrating the method of the present invention.

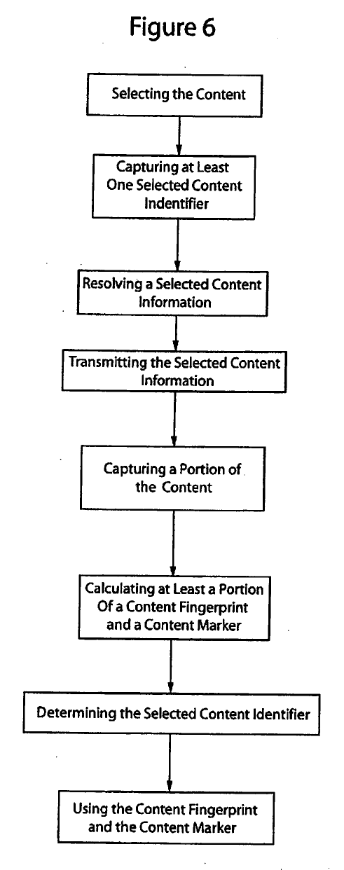

### DETAILED DESCRIPTION OF THE PREFERRED EMBODIMENTS

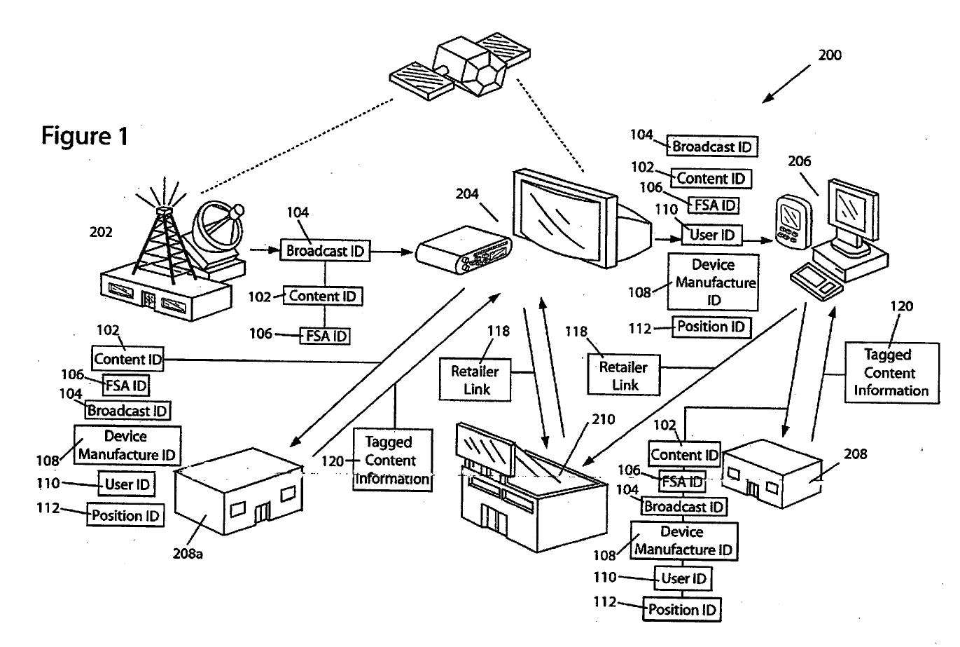

FIG. 1 illustrates a system 200 of associating identifiers with content and sending those identifiers to a “Full Service Aggregator” (or FSA) who returns information or commerce opportunities specific to the tagged content. Identifiers can include Content ID 102, Broadcast ID 104, FSA ID 106, Device Manufacturer ID 108, User ID 110, and Position ID 112. Content ID 102, Broadcast ID 104 and FSA ID 106 are typically provided by a broadcaster 202. Receiving device 204 is typically a car stereo or entertainment center (including a radio, television and CD and DVD players and recorders), television, cable decoding box, satellite decoding box, digital video recorder, and portable radio and video playback devices. Receiving Device 204 can, in one embodiment, provide the Device Manufacturer ID 108, User ID 110, and Position ID 112. Position ID 112 can be provided by a GPS system external to the Receiving Device 204, can be determined by triangulation of cellular signals in relationship to known cell towers, or can be determined using the user's address information (home, school, work).

Each piece of broadcast content 100 that has an associated commerce opportunity or information opportunity has a Content ID 102. Some or all of the identifiers 102, 104, 106, 112 may be present in the broadcast stream. For example, identifiers can be present in a Radio Data Signal (RDS) for FM Radio, embedded metadata for digital radio or satellite radio, embedded in audio watermarks, embedded in the television signal, encoded in physical media, or generated using fingerprints and/or markers. The identifier to content mapping may be provided by the FSA 208 to the broadcaster 202 or vice versa, so long as the associated FSA 208 is capable of determining what piece of content is referenced by a Content ID 102. FSA 208 maintains, in one embodiment, a database that maps identifiers to various associated commerce opportunities, web sites, and/or information sources.

Alternately, Content ID 102 can be a handle as described in co-pending application Ser. Nos. 09/471,971 and 09/486,759 owned by the same assignee and incorporated herein by reference. The handle and/or the association to commerce opportunities can be handled automatically and each analysis can be handed by the FSA 208 or individual portions of the analysis can be handled by different applications, either local to the FSA 208 or remote and connected over a network.

Broadcaster 202 typically includes, at a minimum, Content ID 102. However, in other embodiments Content ID 102, Broadcast ID 104, and FSA ID 106 are transmitted with content 100. The identifiers 102, 104, 106, 112 can be broadcast for each piece of content 100 that has commerce or information data available. In one embodiment, each unique piece of content 100 has a unique content identifier e.g. Content ID 102. Broadcaster 202 may use one FSA 208 to service all of its content, in which case the same FSA ID 106 is broadcast for all content. Alternately, broadcaster 202 may use different FSAs 208, 208A for different pieces of content, thus FSA ID 106 can vary across time depending on the content being played/displayed or multiple FSA IDs 208 can be transmitted depending on the arrangement between the broadcaster 202 and the FSAs 208 or the broadcaster 202 and the retailers 210. Other related information, such as a date and time stamp may be in the stream or generated by the receiving device 204.

In the embodiment illustrated in FIG. 1, identifiers 102, 104, 106 are part of the content broadcast stream, the receiving device 204 can store the identifiers associated with the piece of content 100 currently being broadcast when the user clicks the “Info Button”. The receiving device can add the Device Manufacturer ID 108 and User ID 110. Content 100 becomes tagged content 100A and the stored identifiers can be transmitted to the FSA 208 directly, transmitted, wirelessly or otherwise to an intermediate device 206 and/or written to physical media and transferred to intermediate device 206.

Intermediate device 206 can be any network enabled device that can, in one embodiment, transmit the identifiers 102, 104, 106, 108, 110, 112 to FSA 208. For example, intermediate device 206 can be a computer, portable digital assistant (PDA), laptop, or cellular phone. Each device can receive a transmission from the receiving device 204 and relay it to FSA 208 or can alternately read the physical media and then relay the identifiers 102, 104, 106, 108, 110, 112 to FSA 208.

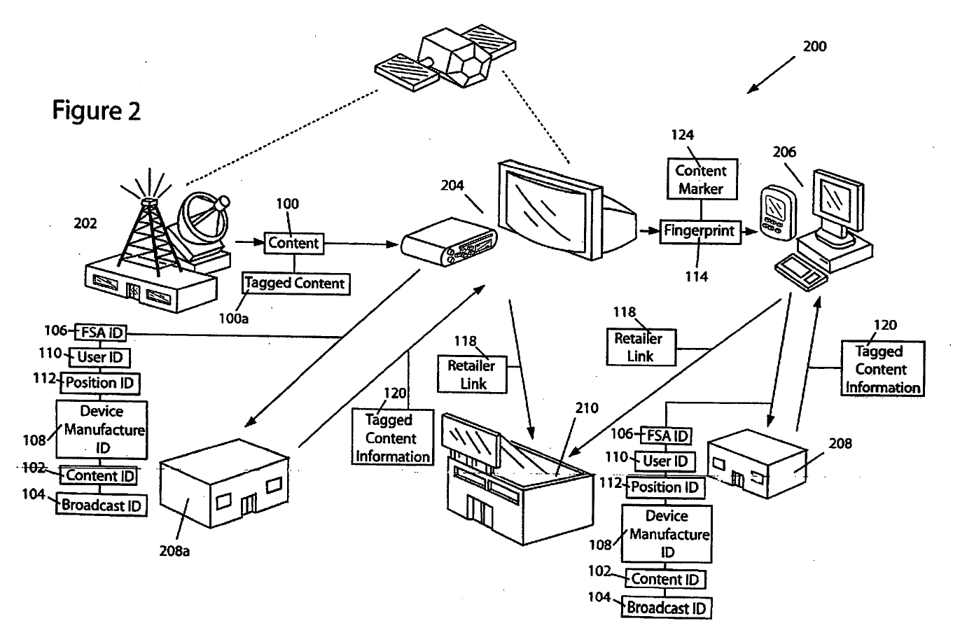

FIG. 2 illustrates an embodiment where a fingerprint 114 or a content marker 124 is used to identify tagged content 100a and/or broadcaster 202. The receiving device 204 captures a portion of the tagged content 100a for later processing and the capturing is prompted when the user presses the Info Button. Fingerprint 114 is computed from the captured content and can be analyzed by receiving device 204 or intermediate device 206 and converted into at least one of a Content ID 102 and a Broadcast ID 104 or used as the Content ID 102. The fingerprints 114 can be determined by analyzing beat, frequencies and instruments in the content 100. Content markers 126 can be a time and date stamp, a length of the broadcast of the content a broadcast station identification, watermark or any other identifier of the tagged content 100a and/or broadcaster 202. The content marker 124 is analyzed to determine the identifiers. For example, a 5 or 10 second sample of the content can be taken and analyzed to determine the content. A time and date identifier can be compared to a play list to determine the content played at the particular time. Further, radio transmits identifiers or signals that can be converted to text identifiers by the receiving device 204. The text is typically the name of the broadcaster, content and content artist and the signal and/or text can be analyzed to determine a Content ID 102 and a Broadcast ID 104. Similar signals are transmitted for television broadcasts. Examples of identifiers or signals present in the broadcast stream are Radio Data Systems (RDS) in the case of FM Radio, embedded metadata in the case of digital radio or satellite radio, and embedded identifiers in audio watermarks.

Once fingerprint 114 and/or content marker 124 is analyzed and converted into or used as the appropriate Content ID 102 and Broadcast ID 104, the FSA ID 106 can be retrieved or determined. Receiving device 204 and intermediate device 206 can contain a listing of broadcasters 202 and their associated FSAs 208 and supply the appropriate FSA ID 106. The list can be updated as necessary and can also be provided on physical media or flashed to the memory of either device via a wired or wireless network transmission. Alternately, one FSA 208 can be designated for a region and the FSA ID 106 can be known from Position ID 112. Further, FSAs 208 can query receiving device 204 and intermediate device 206 and retrieve the identifiers related to the Broadcast ID 104 that FSA 208 services.

Regardless of how the identifiers 102, 104, 106, 108, 110, 112 are received, the identifiers 102, 104, 106, 108, 110, 112, fingerprint 114, content markers 124 and/or the tagged content 100a can be encrypted when stored. The receiving device 204 may optionally include a device manufacturer ID 108 and/or date and time stamp with the data it captures.

In another embodiment, receiving device 204 may only enable (e.g. light up) the Info Button when it detects identifiers in the broadcast stream. This enables the user to determine which content 100 can be tagged content 100a and prevents the user from clicking content 100 that has no associated commerce opportunity. In this embodiment, if broadcaster 202 does not have an FSA 208 associated with a given piece of content 100 or the FSA 208 has no commerce or informational opportunities for the content 100, broadcaster 202 does not include Content ID 102 in the broadcast stream.

In an embodiment, receiving device 204 with some or all identifiers 102, 104, 106, 108, 110, 112, fingerprint 114, and/or content marker 124 transmits the data to the FSA 208 directly. In an alternate embodiment, the identifiers 102, 104, 106, 108, 110, 112, content marker 124 and/or fingerprint 114 are transmitted to an intermediate device 206, for example a computer, cellular telephone, PDA or similar network-connected device via, at least one of, removable media, Bluetooth, networking, wireless transmission or other transport mechanism. Intermediate device 206 collects the identifiers 102, 104, 106, 108, 110, 112 and transmits them to the appropriate FSA 208. The FSA 208 looks up the identifiers 102, 104, 106, 108, 110, 112, for example in its content mapping database, and returns relevant information 120 regarding the tagged content 100a to be displayed to the user on at least one of the receiving device 204 or intermediate device 206.

In one embodiment, after receiving the identifiers 102, 104, 106, 108, 110, 112 and determining what commerce opportunities should be presented to the user, the FSA 208 returns a small HTML page incorporating the relevant links 118. In another embodiment, instead of returning HTML, the FSA 208 returns an XML document. The receiving device 204 or intermediate device 206 then uses a style sheet, such as an XSLT style sheet, obtained from a central authority to format the XML into a page that can be displayed to the user. This allows a consistent look and feel to apply across all FSAs 208.

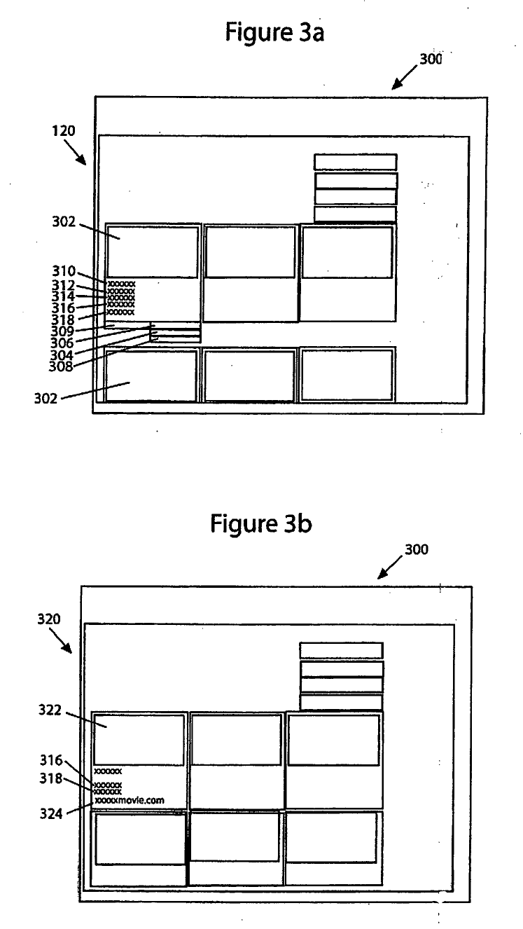

FIGS. 3a and 3b illustrate a user display 300 after FSA 208 returns tagged content information 120. For example, FIG. 3a illustrates that if the tagged content 100a is a song, the FSA 208 may return HTML with the CD cover art 302 and web links to “Buy CD,” 304 “Buy Download” 306 “Buy Tickets” 308 and “Preview” 309. Additional information can include a name of the artist and/or band 310, the album 312 on which the tagged content 100a is available, the tagged content 100a title 314, the time and date the content was tagged 316 and a broadcaster identifier 318. The broadcaster identifier 318 can be one or both of the FCC call letters and the public broadcaster identification (i.e. KYSR-FM and/or Wild 93.9). In another embodiment, user display 300 can show content information 120 for advertisements 320.

In an embodiment, a still image is displayed identifying the vendor 322. Links 324 can be displayed allowing the user to play back the advertisement, purchase the item, receive directions, or visit the vendor's website. Additionally, the time 316 and broadcaster identifier 318 can also be displayed. Typically, once a user selects tagged content information 120 the user is taken directly to the commerce opportunity.

Receiving device 204 or intermediate device 206 determines which FSA 208 to send the identifiers to by either using the FSA ID 106 or if no FSA ID is present, using a look-up database, fingerprint 114 or content marker 124.

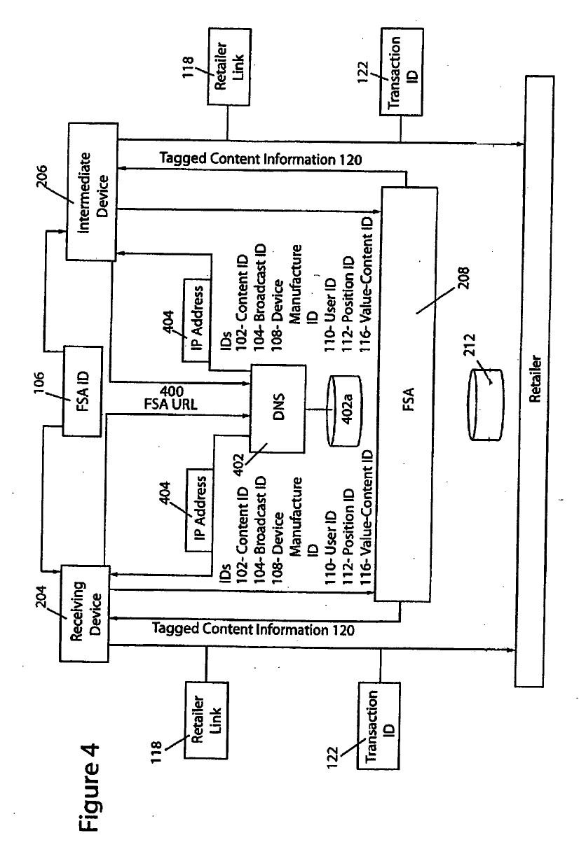

FIG. 4 illustrates embodiments where one or more FSA ID 106 to FSA URL 400 resolution techniques can be used. One embodiment is where FSA ID 106 is included in the broadcast stream. For example, the FSA ID 106 can actually be a URL 400 (e.g. the FSA ID=www.fsal.com). Alternately, the FSA ID 106 can be part of a URL 400a (e.g. the FSA URL can be www.XX.fsa.com, where XX is replaced by the FSA ID). Once the FSA URL 400 is determined, the normal internet Domain Name Service (DNS) 402 infrastructure can be used to resolve the FSA ID 106 into the FSA's IP address 404. A provider can maintain a top-level DNS name server 402 that contains the FSA URL 400 to actual FSA IP address 404 mapping and, through the normal DNS process, this would be propagated through the internet. When the user's computer attempts to contact the FSA URL 400, the distributed DNS service 402 automatically and efficiently determines the proper FSA IP address 404 and over time this information can be cached around the internet so that the load on the central body's name server 402 is minimized.

In an alternate embodiment, a central body (e.g. the licensor of this invention, a volunteering FSA, or a provider) may maintain a database of FSA ID to URL mappings 402a that is queried by the receiving device 204 or intermediate device 206. Additionally, requests can be redirected through a web site (e.g. maintained by the hardware vendor or whoever supplies the computer software bundled with the receiver) that has an FSA ID to URL mapping database 402a.

A further embodiment, FSA ID 106 is not included in the broadcast stream and a Content ID 102 to FSA ID 106 table, maintained by a central body or peered across all FSAs, can be consulted to determine the proper FSA ID 106.

The FSA 208 determines what tagged content information 120 to return to the receiving device 204 or intermediate device 206 based on the identifiers 102, 104, 108, 110, 112 it receives from the receiving device 204 or intermediate device 206, and optionally business rules and user context information. (Specific types of business rules, context information and their resolution is disclosed in pending application Ser. Nos. 09/471,971 and 09/614,106 incorporated herein by reference.) For example, receiving device 204 or intermediate device 206 may provide, as part of or along with the Device Manufacture ID 108 or User ID 110 user-context information such as device platform, preferred media player, preferred retailers 210, financial information, and territory to the FSA along with the Content ID 102 and value-chain identifiers 116 so that the FSA 208 can, in one embodiment, customize its response to the user. Alternatively, the FSA 208 may provide the user with a choice of different retailers 210.

An FSA 208 may have arrangements with multiple retailers 210 and an agreement between the FSA 208 and the broadcaster 202, user context information, or user preference may determine the form and format of the tagged content information 120. For example, FSA 208 may have six different retailers 210 to choose from for digital downloads: one specific to the Macintosh® platform, one offering downloads at a higher quality than the others, one services a particular genre of music only, one offers better contractual terms than the others, one is associated with a particular device manufacturer, and one has a special deal with a particular broadcaster 202. Therefore, the deals the FSA 208 has in place with the broadcaster 202, device manufacturers, and retailers 210 can determine what subset of options are presented to the user. The users' particular information, e.g. platform, quality preferences, and format preferences, can further narrow the options for the tagged content information 120.

When multiple options are available, the FSA 208 can use a rules engine to determine what to present to the user. The rules engine may be used either to narrow the choices initially presented to the user (“Buy CD from Amazon®”) or if the initial response to the user is generic (“Buy CD”) then the rules engine can narrow the choices after the user clicks their selection. In case of the former, the user can be taken directly to the retailer 210 while in the latter the user would be routed back through the FSA 208 which would determine where to send the user and then forward the user on to the resulting URL.

An FSA 208 content database can, in one embodiment, typically contain three types of data associated with each Content ID 102/Broadcast ID 106 pair: (1) a list of what commerce opportunities are available, (2) information needed to construct a retailer ID 118 URL pointing to the commerce opportunities (e.g. FSA content ID to retailer content ID translation), (3) content metadata (e.g. track name, artist name, album name, and cover art).

FSAs are responsible for providing different commerce opportunities for a piece of content. For example, for a song, an FSA may have deals with Amazon.com® to sell CDs, with iTunes.com® to sell digital downloads, with Ticketmaster.com® to sell tickets, and with the All Music Guide (AMG) to provide artist biography and discography information.

The FSA 208 typically has an arrangement with retailers 210 so that when a sale is completed the FSA 208 is paid an affiliate fee or bounty. The FSA 208 can include a Transaction ID 122 in the retailer link or Retailer ID 118 clicked by the user so that the retailer 210 can track the transaction and report back to the FSA 208 later with a full accounting. The FSA 208 can maintain a transaction database 212 used to map from a Transaction ID 122 to the Content ID 102, and if known, Broadcast ID 104, Device manufacturer ID 108 and User ID 110. In an embodiment, the FSA 208 can pay the broadcaster 202 a portion of any fee or bounty.

In an embodiment, receiving device 204 or intermediate device 206 can encrypt some or all of the identifiers 102, 104, 106, 110, 112, content marker 124 and/or fingerprint 114. The FSA 208 can require a decryption key from the device manufacturer before it can transmit the tagged content information 120. This ensures that the FSA 208 has an incentive to deal with the device manufacturer to reward them when their device leads to a sale.

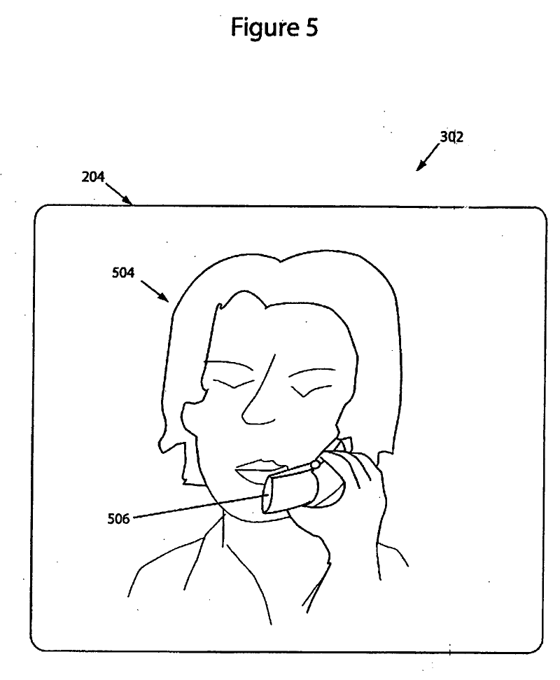

Further, as illustrated in FIG. 5, the present invention can also identify sub-content. Sub-content 500 is typically bundled with or in content 100. For example, a television program 502 can display a character 504 using a cellular telephone 506. Pressing the Info Button captures the content 100 and the sub-content 500 in the image. The tagged content 100a can be the broadcaster 202, actress 504 and the name television show. Tagged sub-content can be the make and model of the cell phone 506 and/or the name and artist of the audio track that is playing in the background of the scene. Identifiers 102, 104, 106, 108, 110, 112 can be similar to the identifiers noted above and the commerce opportunities to purchase the last season of the television show, movies related to the actress, cellular phone and the soundtrack are available to the user.

### EXAMPLE OF THE INVENTION

This section describes a specific embodiment. For this example, assume that a digital radio station uses one FSA to fulfill all of its music content and that when a sale results from a user click, all of the value-chain participants are compensated. The exemplary system uses 24 bit identifiers for Content IDs 102 as well as Broadcast IDs 104, FSA IDs 106, and Device Manufacturer IDs 108 and that these identifiers are obtained from a central licensing authority. This central authority also maintains the DNS entries needed for FSA resolution.

1) The radio station 202 assigns a 24 bit number for each piece of content 100 in its catalog of ads and songs. The station 202 sends a list of songs (e.g. identified by the track name, artist name, album name, and music industry standard ISRC identifier) along with the 24 bit identifier 102 for each piece of content 100 to its FSA 208. It obtains the 24 bit identifier 106 for its FSA 208. To identify itself, the station obtains a 24 bit identifier 104 (say, from a central licensing authority). When the station 202 broadcasts content, it includes three identifiers 102, 104, 106 in the broadcast stream along with any other metadata. The identifiers are repeated throughout the broadcast.

24 bits: Content ID 102

24 bits: Broadcast ID 104

24 bits: FSA ID 106

2) A user listening to a digital radio 204 in their car hears something interesting and presses the “Info Button”. When the Info Button is pushed, the radio captures the identifiers and stores them on removable media (e.g. a USB flash RAM key). The radio 204 encrypts the first 48 bits (Broadcast & Content IDs 104, 102) with a device manufacturer-specific key and appends its 24 bit Device Manufacturer ID 108 to the end of the 72 bits, creating a 96 bit string. Every time the user clicks the Info Button another entry is created in a file on the USB key. The resulting entry for a tagged piece of content will look like:

Encrypted with the device manufacturer key

[24 bits: Broadcast ID 104 and 24 bits: Content ID 102] and

24 bits: FSA ID 106

24 bits: Device Manufacturer ID 108

3) When the user removes the USB key from the radio 204 and inserts it into their computer 206, software detects the USB key and the file containing the tagged content information. The software can open a web browser with a page that consists of frames and constructs a URL 400, 400a for each frame of the format
www.XX.fsa.org?IDENTIFIERS
where XX is replaced by the FSA ID 106 converted into a hexadecimal number. A central body maintains the top level internet DNS servers 402 that map www.XX.fsa.org addresses to specific FSA IP addresses 404. In this case, normal internet DNS 402 is used to resolve the FSA URL 400, 400a from the FSA ID 106. IDENTIFIERS is replaced with a hex format of the identifiers associated with the tagged content 100a (i.e. Encrypted with the device manufacturer key [24 bits: Broadcaster ID 104, 24 bits: Content ID 102]
24 bits: FSA ID 106
24 bits: Device Manufacturer ID 108.
In this example, the central licensing authority maintains the top level DNS entries for fsa.org with the FSA ID to URL mappings so the IP address for the FSA identified by the broadcaster is resolved through the normal internet DNS mechanism.

4) The FSA 208 receives the identifiers 102, 104, 106, 108 at its web server and converts it back into a binary number. The FSA 208 identifies which receiving device 204 was used by examining the final appended 24 bits (Device Manufacturer ID 108). If FSA 208 has an arrangement with the device manufacturer in question, FSA 208 requires a decryption key needed to decrypt the Broadcast and Content IDs and the IDs will be used to look-up the various commerce opportunities in the FSA's database. For example, the FSA may have an arrangement with Amazon.com® to sell the CD with the tagged content 100a and with iTunes.com® to sell the tagged content 100a as a digital download. In this case, FSA 108 looks up the content/broadcaster combination in a database, and finds that it can offer a CD link through Amazon and a download link through iTunes. The database also contains the information the FSA 208 needs to construct a URL that will take the user to those commerce opportunities.

Using the URL information, the FSA 208 creates a small HTML page returned to the user. This page includes links to buy a download from iTunes.com® or buy a CD from Amazon.com®, along with song metadata (e.g. artist name, album name, track name, and cover image).

The link to the retailer will include a Transaction ID 122 and the FSA's retail affiliate ID (or whatever the retailer needs to identify the FSA) so when the retailer completes the sale it knows to pay the FSA 208 and the FSA 208 can use the Transaction ID 122 to determine who it, in turn, should pay. Therefore prior to returning the HTML page to the user, the FSA must also create an entry in a transaction database with the Content ID 102, Broadcast ID 104, and Device Manufacturer ID 108.

5) Each frame of the page in the user's web browser is populated by a different HTML page returned from the associated FSA 208. Because each frame has its own URL, note that the final page may contain content from a wide variety of FSAs 208, 208a. In fact, this is the expected case when the user tags content from different broadcasters, since different broadcasters may have different FSAs (or a single broadcaster may use different FSAs for different pieces of content). When the user clicks on a link, they are taken directly to the iTunes.com or Amazon.com page with the content 100a in question.

6) If a sale is made, the retailer 210 notifies the FSA 208 with a Transaction ID 122. The FSA 208 looks the Transaction ID 122 up in its database to find the broadcaster 202 and device manufacturer. It can then split the affiliate fee paid by the retailer with the broadcaster and device manufacturer.

While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature.

We claim:

1) A method for determining at least one of information and a commerce opportunity for content in a broadcast stream such as an internet radio stream or FM broadcast,, comprising the steps of:
selecting, by the user, a specific piece of content in the stream;
capturing at least one selected content identifier associated with the selected content;
transmitting the at least one selected content identifier to an FSA; and
resolving, by the FSA, the at least one selected content identifier into a selected content information containing at least one of the information and the commerce opportunity.

2) The method of claim 1, further comprising the step of transmitting the selected content information to the user.

3) The method of claim 1, wherein the capturing step comprises the steps of:
capturing a portion of the content;
calculating at least one of a content fingerprint and a content marker;
optionally, determining the at least one selected content identifier from at least one of the content fingerprint and the content marker; and
optionally, using at least one of the content fingerprint and the content marker as the tagged content identifier.

4) A system for enabling commerce associated with broadcast content comprising:
a broadcast system such as a FM radio station, digital TV station, internet radio streaming server, etc. which includes content and broadcaster identifiers with broadcast content
a receiving device having a built in or peripheral “Info button” such as an FM radio or TV with an info button on the remote control, which captures identifiers present in the broadcast stream when the Info button is pressed;
a processor designed to take the identifiers captured by the receiving device and forward them over a digital network such as the internet to a resolving service and presents the results received back from the resolving service to the user;
a resolving service maintaining a database of identifiers and associated purchase or information opportunities at retail, advertiser, or 3rd party web sites and which looks up the identifiers it receives and returns relevant purchase or information options back to a user.

5) The system as in claim 4, wherein identifiers are generated using audio fingerprints and content markers,
wherein the receiving device captures portions of the audio rather than identifiers,
wherein the processor generates an audio fingerprint from the captured audio and sends it to the resolving service, and
wherein the resolving service content database maps the fingerprints it receives to the purchase or information opportunities.

6) The system as in claim 4, wherein data in the broadcast stream identifies which resolving service to use.

7) The system as in claim 4, wherein the data in the broadcast stream identifies the broadcaster and/or where the receiving device includes a device identifier and either or both identifiers are sent to the resolving service.

8) The system as in claim 4 wherein some or all of the identifiers are encrypted.

9) The system as in claim 4 where the resolving service maintains a database of transactions forwarded to retail, advertiser, or 3rd party web sites for the purpose of paying one or both of the broadcaster and device manufacturer when a transaction results in a sale to the user, ad click, or other revenue generating event.

10) The system as in claim 4, further comprising a Domain Name Service (DNS) resolving the resolving service identifier in the resolving service address.

11) The system as in claim 4, wherein the broadcaster is an internet streaming service.

12) A method or determining at least one of information and a commerce opportunity for content in a broadcast stream such as an internet radio stream or FM broadcast,, comprising the steps of:
selecting a piece of content;
capturing at least one identifier associated with the content;
forwarding the content identifier and other relevant identifiers to a resolving service;
computing information or purchase opportunities associated with the identified content; and
returning the information or purchase opportunities to the user.

13) A method for generating a fingerprint, comprising the steps of:
selecting a piece of content;
capturing a portion of the content;
computing a fingerprint from the captured portion; and
using the fingerprint as the selected content identifier or determining the selected content identifier from the fingerprint.

14) A method for generating a marker; comprising the steps of:
selecting a piece of content;
capturing a content marker;
determining the selected content identifier; and
using the content identifier.
